(19) United States
(12) Patent Application Publication
(10) Pub. No.: US 2020/0262718 A1
(43) Pub. Date: Aug. 20, 2020

(54) Water Purification System

(71) Applicant: OLIMAX INC, Freeland, WA (US)

(72) Inventors: Oliver James Groves, Freeland, WA (US); Craig McNinch, San Lorenzo, CA (US); Richard Curtis Delmonte, Freeland, WA (US)

(73) Assignee: OLIMAX INC, Freeland, WA (US)

(21) Appl. No.: 16/276,944

(22) Filed: Feb. 15, 2019

(51) Int. Cl. C02F 1/06; C02F 9/00; C02F 1/14; B01D 1/00; B01D 5/00

(52) U.S. Cl. CPC C02F 1/06; C02F 9/00; C02F 1/14; B01D 1/0035; C02F 1/004; B01D 5/0003; B01D 5/006; B01D 5/0072; B01D 5/009; B01D 1/0082

(57) ABSTRACT

A water purification system comprising a salvage pump, a salvage assembly, a vacuum assembly, and a clean water assembly. The salvage pump is configured to draw water from a water source. The salvage assembly is configured to store and heat water drawn from the water source. The vacuum assembly is configured to remove solutes from the water via vacuum evaporation. The clean water assembly is configured to remove non-soluble particles and/or bacteria from the water.

### TECHNICAL FIELD

The present application, in some embodiments thereof, relates to water purification systems for converting contaminated water to potable water.

### BACKGROUND

The need for clean energy and water availability has always been an environmental issue throughout the world. Contaminated water is especially a problem, since it is not suitable for basic human uses such as drinking, bathing, and preparing food. Therefore, there exists a need for an efficient, low-energy water system requiring a minimal amount of maintenance.

### BRIEF SUMMARY OF THE INVENTION

An aim of the system of the present invention is to provide a water purification system that uses low power and can yield potable water from contaminated water sources.

Another aim of the present invention is to provide a compact water purification and/or desalination system configured for a family home or shared with a neighborhood community.

Therefore, an aspect of some embodiments of the present invention relates to a water purification system comprising a salvage pump, a salvage assembly, a vacuum assembly, and a clean water assembly. The salvage pump is configured to draw water from a water source. The salvage assembly includes: a salvage tank configured to store water drawn by the salvage pump; a hot water tank, configured to receive water from the salvage tank and for heating and storing the received water; a first pump, configured to pump water from the salvage tank to the hot water tank; and a salvage valve, configured to regulate water flow out of the hot water tank. The vacuum assembly includes: a vacuum tank, configured to receive water from the hot water tank; a vacuum pump, configured to lower pressure inside the vacuum tank to cause evaporation of water stored in the vacuum tank, and to draw water vapor from the vacuum tank; an atmospheric tank, configured to be maintained at an atmospheric pressure and to receive the water vapor drawn by the vacuum tank, the atmospheric tank being configured to transform water vapor received from the vacuum pump into water; a heat exchanger pipe traversing the atmospheric water tank and configured to lead water from the salvage pump to the salvage tank without contacting the water and water vapor in the atmospheric tank, thereby warming the water in the heat exchanger pipe while cooling the water and water vapor inside the atmospheric tank; and a second pump, configured to draw water out of the atmospheric tank. The clean water assembly, includes: a plurality of filters, configured to filter water drawn by the second pump; a clean tank, configured to receiving water that has been filtered by the plurality of filters; a third pump, configured for drawing water from the clean tank to a water storage tank; and a fourth pump, configured for drawing water from the clean tank and leading the water drawn from the clean tank into a further purification cycle.

In a variant, the water purification system, further includes a fifth pump and a solar collector. The fifth pump is configured to drive water from an outlet of the salvage tank to an inlet of the solar collector, via the solar collector, via an outlet of the solar collector, and back into the salvage tank via an inlet of the salvage tank. The solar collector is configured for using solar power to heat water flowing in the solar collector.

In another variant, the vacuum assembly comprises a brine tank located under the vacuum tank and communicating with the vacuum tank via a first water line opened and closed via a first valve. When the first valve is opened, brine collected at a bottom of the vacuum tank enters the brine tank.

Optionally, the vacuum assembly comprises a waste tray located under an outlet of the brine tank. The outlet of the brine tank is opened and closed via a second valve. When the second valve is opened, the brine collected in the brine tank enters the waste tray.

The waste tray may be removable from under the outlet of the brine tank.

In a further variant, the water purification system further comprises a fluoride water filter located downstream of the second pump.

In yet another variant, the clean water assembly comprises a manifold, at least one ion exchange tank, a carbon tank, a cation tank, and an anion tank. The manifold comprises an inlet for receiving water from the second pump, a first exit line, a second exit line, and a third exit line, each exit line being openable and closable by a respective valve. The first exit line leads to the least one ion exchange tank. The at least one ion exchange tank has an outlet leading to the carbon tank, which has a first outlet leading to the clean tank. The second exit line leads to the cation tank, which has a second outlet leading to the clean tank. The third exit line leased to the anion tank, which has a third outlet leading to the clean tank. The at least one ion exchange tank and the carbon tank are configured to balance the pH of water flowing therethrough. The cation tank contains H⁺ ions, and is configured to decrease a basicity of water flowing therethrough by neutralizing excess OH⁻ ions in the water with the H⁺ ions in the cation tank. The anion tank contains OH⁻ ions, and is configured to decrease an acidity of water flowing therethrough by neutralizing excess H⁺ ions in the water with the OH⁻ ions in the anion tank.

The water purification system may comprise an initial filter located upstream of the manifold and configured for retaining particles larger than a first predetermined size.

The water purification system may comprise a second filter located between the carbon tank and the clean tank, and configured for retaining particles larger than a second predetermined size.

The water purification system may comprise an ultra violet (UV) treatment device located upstream of the manifold and configured to expose water to UV light to kill bacteria in the water.

In a variant, the fourth pump is configured to draw water from the clean tank and deliver the water to a first return water line and to a second return water line. The first return water line leads water drawn by the fourth pump back to the plurality of filters. The second return water line leads water drawn by the fourth pump back to the salvage tank. A first return valve is located along the first return water line to enable the first return water line to be opened and closed. A second return valve is located along the second return water line to enable the second return water line to be opened and closed.

In another variant, the water purification system further comprises a water flow meter installed along any water line of the system to monitor an amount of water used in the system.

In yet another variant, the hot water tank comprises a first temperature gauge and a heating element. The first temperature gauge is configured to measure temperature of the water in the hot water tank and for activating the heating element so as to maintain the water in the hot water tank above a desired temperature or within a desired range of temperatures.

In a further variant, the water purification system includes: a first level control unit configured to monitor a first water level in the salvage tank; a second level control unit configured to monitor a second water level in the hot water tank; a third level control unit configured to monitor a third water level in the vacuum tank; a fourth level control unit configured to monitor a fourth water level in the atmospheric tank; a fifth level control unit configured to monitor a fifth water level in the clean tank; a sixth level control unit configured to monitor a sixth water level in the water storage tank; and a first temperature gauge is configured to measure temperature of the water in the hot water tank.

In a variant, the salvage pump is configured to be activated if the first level control unit indicates that the first water level in the salvage tank is below a predetermined level. The first pump is configured to be activated: if the first level control unit indicates that the first water level in the salvage tank is above a first predetermined level and the second level control unit indicates that the second water level in the hot water tank is below a second predetermined level; or if the second level control unit indicates that the second water level in the hot water tank is above a third predetermined level, and the third level control unit indicates that the third water level in the vacuum water tank is below a fourth predetermined level, and the first temperature gauge indicates that the temperature of the water in the hot water tank is higher than a first predetermined temperature. The vacuum pump is activated if the third level control unit indicates that the third water level inside the vacuum tank is above a fifth predetermined level and the fourth level control unit indicated that the fourth water level in the atmospheric tank is below a sixth predetermined level. The second pump is activated if the fourth level control unit indicates that the fourth water level in the atmospheric tank is above a seventh predetermined level and the fifth level control unit indicates that the fifth water level in the clean tank is below an eighth predetermined level. The third pump is activated if the fifth level control unit indicates that the fifth water level in the clean tank is above a ninth predetermined level and the sixth level control unit indicates that the sixth water level is below an eleventh predetermined level. The fourth is activated either by an outside input or if the fifth level control unit indicates that the fifth water level in the clean tank is above a ninth predetermined level and the sixth level control unit indicates that the sixth water level is below an eleventh predetermined level.

Optionally, the salvage valve remains open if and only if the second level control unit indicates that the second water level in the hot water tank is above a third predetermined level, and the third level control unit indicates that the third water level in the vacuum water tank is below a fourth predetermined level, and the first temperature gauge indicates that the temperature of the water in the hot water tank is higher than a first predetermined temperature.

In another variant, the sixth pump is activated when the first level control unit indicates that the first water level in the salvage tank is above the first predetermined level.

In yet another variant, the water purification system further includes a temperature probe configured for measuring a temperature of water in the vacuum tank.

In yet another variant, the water purification system includes a central control unit configured for receiving inputs from at least some of the level control units and from the temperature gauge, and for activating the salvage pump, the vacuum pump, the first pump, the second pump, the third pump, the fourth pump, and the fifth pump accordingly.

In a further variant, outputs from at least some of the level control units and from the temperature gauge are displayed for being readable by a user, and each pump and valve is configured to be activated by the user.

### BRIEF DESCRIPTION OF DRAWINGS

FIG. 1 is a block diagram showing a water purification system, according to some embodiments of the present invention;

FIG. 2 is a block diagram illustrating an example of an electrical power apparatus for automatically controlling electrical power flow to the different units of the water purification system of FIG. 1;

FIG. 3 is a block diagram illustrating some embodiments of the present invention, in which the operation of the system of FIG. 1 is configured to be controlled by a central control unit;

FIG. 4 is a block diagram illustrating a vacuum assembly of a water purification system of FIG. 1, which includes a plurality of vacuum pumps in parallel with each other;

FIG. 5 is a block diagram illustrating an example of the power supply for the water purification system of FIG. 1, according to some embodiments of the present invention;

FIGS. 6a and 6b are respectively an isometric view and a top view illustrating an example of the water purification system, according to some embodiments of the present invention;

FIG. 7 is an isometric view of an example of a salvage assembly of the water purification system, according to some embodiments of the present invention;

FIGS. 8 and 9 are isometric views of an example of a vacuum assembly of the water purification system, according to some embodiments of the present invention; and

FIG. 10 is an isometric view of an example of a clean water assembly of the water purification system, according to some embodiments of the present invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

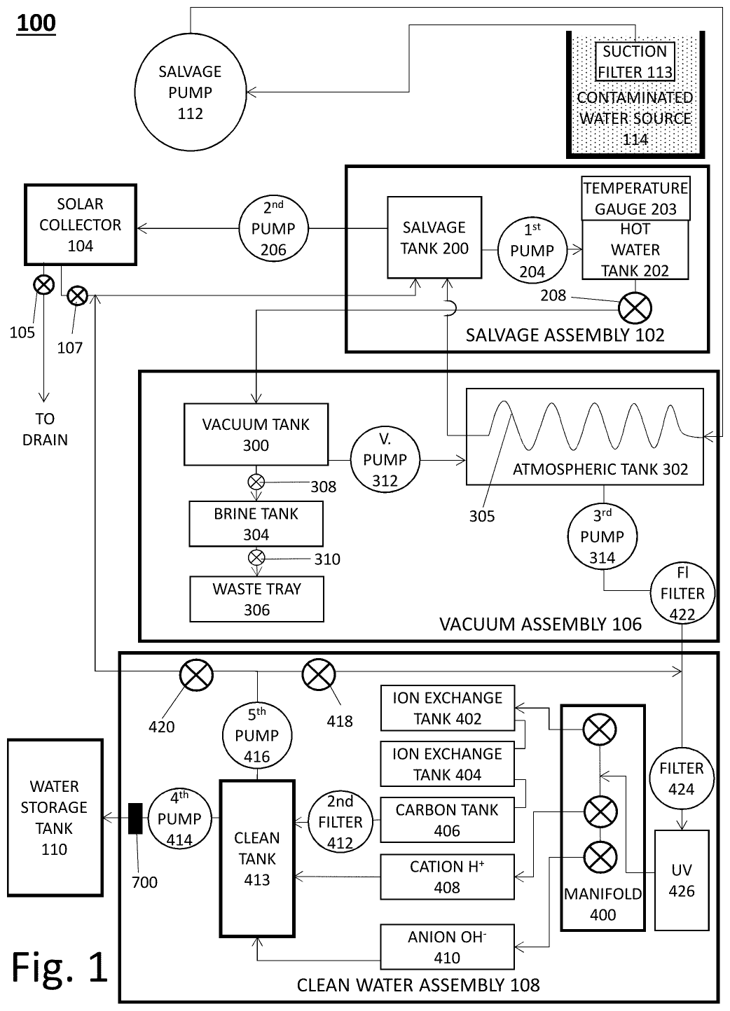

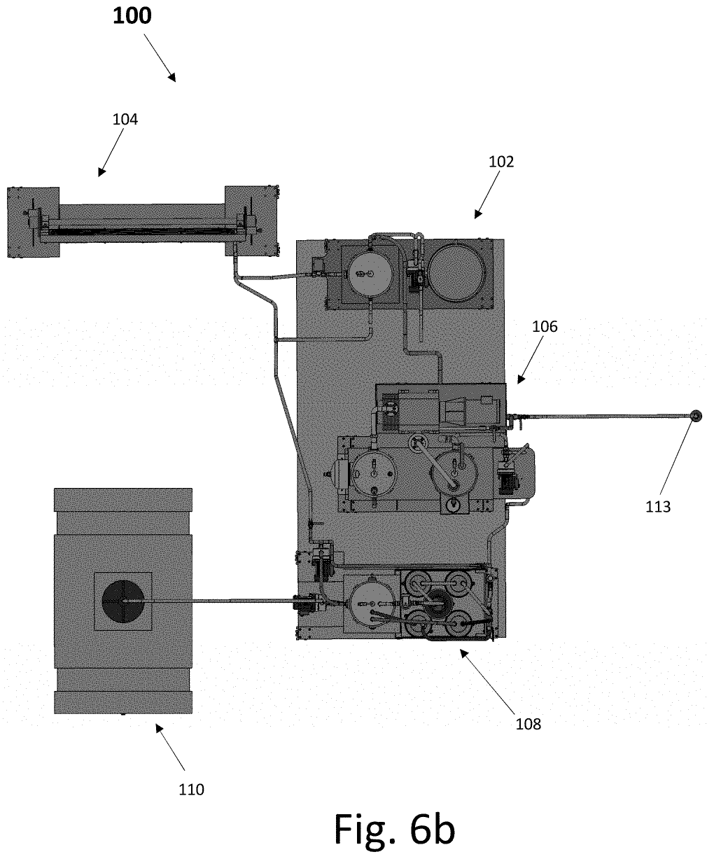

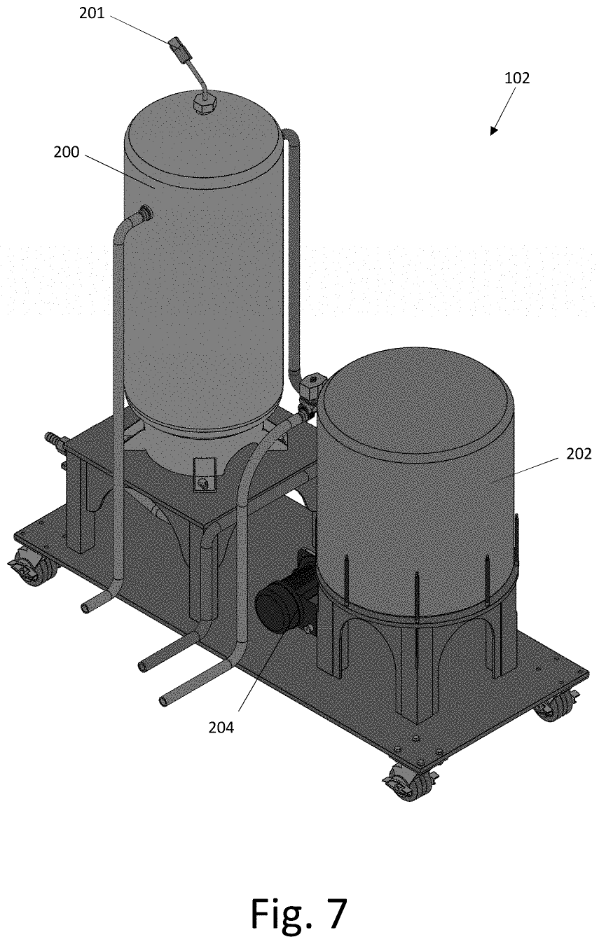

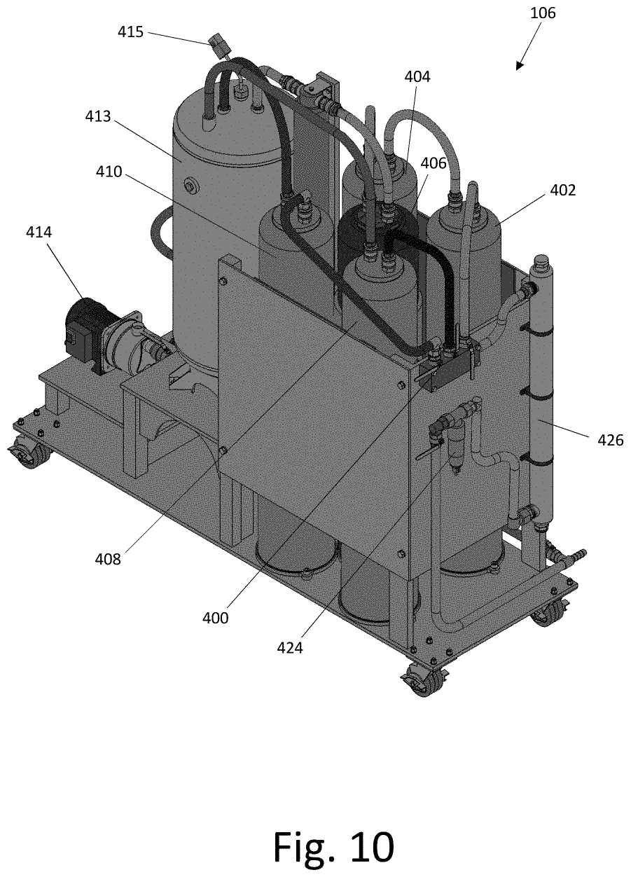

Referring now to FIGS. 1 and 4-10, a water purification system 100 of the present invention includes a salvage assembly 102, a solar collector 104, a vacuum assembly 106, a clean water assembly 108, and a water storage tank 110.

A salvage pump 112 draws water from a contaminated water source 114. In some embodiments of the present invention, a suction filter 113 is located below the water surface at an elevation above or below the salvage water pump 112 and is configured for preventing particles in the water source that are larger than a predetermined size (e.g., 50 microns) from entering the system 100.

The salvage assembly 102 includes a salvage tank 200, a hot water tank 202, and a first pump 204. The salvage tank 200 is configured for receiving and storing the water from the water source 114. Before being brought to the salvage tank, the water is pumped by the salvage pump 112 through a heat exchange pipe 305 that passes inside the atmospheric tank 302 (which will be described further below). In the heat exchange pipe 305, the source water is heated by absorbing heat of the water and/or water vapor in the atmospheric tank 302, thereby cooling the water and/or water vapor in the atmospheric tank 302.

Water in the salvage tank 200 is drawn by the first pump 204 and pumped or transported to the hot water tank 202. The hot water tank 202 includes an electrical heating element to heat the water up to a desired temperature and/or to keep the water within a desired range of temperatures. The hot water tank 202 includes a temperature gauge 203 configured to measure a temperature of the water in the hot water tank 202. The temperature value is used as an input signal to the electrical heating element to maintain the hot water in the hot water tank 202 above the desired temperature or within the desired range of temperatures.

The temperature switch 203 may govern the operation of the electrical heating mechanism, which switches the heating mechanism on when the temperature of the water inside the hot water tank 202 is below the desired temperature and by switching off the heating mechanism when the temperature of the water in the hot tank 202 is at or above the desired temperature. Alternatively, the hot water tank 202 is configured for maintaining the water temperature within a desired range of temperatures. Therefore, when the water temperature is below a first predetermined temperature, the heating element is turned on. When the water temperature is at or above a second predetermined temperature higher than the first predetermined temperature, the heating element is turned off. Hot water from the hot water tank 202 is sent to the vacuum assembly 106 so that salts and contaminants dissolved in the water can be separated.

In some embodiments of the present invention, before the water is guided from the salvage tank 200 to the hot water tank 202, the water in the salvage tank 200 is guided by a second pump 206 to a solar collector 104, where the water is heated and sent back to the salvage tank 200. In this manner, water drawn from the salvage tank to the hot water tank 202 is further heated and the need for heating the water in the hot water tank 202 to the desired temperature is decreased or even obviated.

After having gone through the heat exchange pipe 305 and optionally the solar collector 104, the water inside the salvage tank 202 is at a constant preheated temperature. Once the water in salvage tank 200 reaches a predetermined level at the preheated temperature, the first pump 204 is activated to send the water from the salvage tank 200 to the hot water tank 202. This feature decreases the need to turn the heating mechanism of the hot water tank 202 on and off multiple times.

The solar collector 104 may heat the water via any known solar heating technique. Non-limiting examples of solar heating techniques include black heat absorbing hoses coiled on a flat surface, hot water roof collectors, vacuum tube glass arrays filled with water, etc. The hot water collector shown herein may have several energy efficient characteristics. For example, aluminum corrosion resistance 6063 T6, wave pattern flashing between the tubes, black PVC pipes, rotation of the solar collector surface, etc., are all different methods to absorb heat. The solar collector 104 may include active and/or passive systems. In some embodiments of the present invention, the solar collector 104 has a drain outlet closed by a drain valve 105. The drain valve 105 is closed during the use of the system 100 and may be opened to drain the solar collector 104 when the system 100 is not in use.

The vacuum assembly 106 includes a vacuum tank 300, an atmospheric tank 302, a brine tank 304, and a waste tray 306. The hot water from the hot water tank 202 is received by the vacuum tank 300. The pipe between the hot water tank 202 and the vacuum tank 300 is closed by a salvage valve 208. The salvage valve 208 can be opened to allow water to flow from the hot water tank 202 to the vacuum tank 300. The flow of water from the hot water tank 202 to the vacuum tank 300 is powered by the first pump 204 which draws the water from the salvage tank 200 and pumps it to the hot water tank 202 and further to the vacuum tank 300. The salvage valve 208 is opened when the water in the hot water tank 202 is above a desired temperature or within a desired range of temperatures.

Once the water in the vacuum tank 300 reaches a predetermined control level and temperature level (e.g., 104 degrees Fahrenheit), the first pump 204 is turned off and a vacuum pump 312 is turned on to reach a predetermined vacuum pressure (e.g., 27.75 inHg). This will also lower the air pressure in the vacuum tank 300 so that water evaporates at an increase in vacuum pressure and lower temperature than standard conditions and to pump the water vapor to the atmospheric tank 302. The vacuum pump 312 may be a dry vacuum pump, such as a dry screw vacuum pump.

The surface water in the vacuum tank 300 (along with any oils, if present) evaporates and is thereby separated from the salts and contaminants dissolved therein, to form brine (e.g., a mixture water and salt in which the salt is at least 26% of the mixture) inside the vacuum tank. The vacuum pump 312 pumps the water vapor and oil vapor from the vacuum tank 300 to the atmospheric tank 302, which is kept at atmospheric pressure, while the brine consisting of 26% salt in water solution (salt NaCl having a density of 145 lbs/ft³ as opposed to water density of 62.4 lbs/ft³) is directed by gravity to the brine tank 304. The brine tank 304 is located under the vacuum tank 300 and is connected to the vacuum tank 300 via a pipe with a top valve 308.

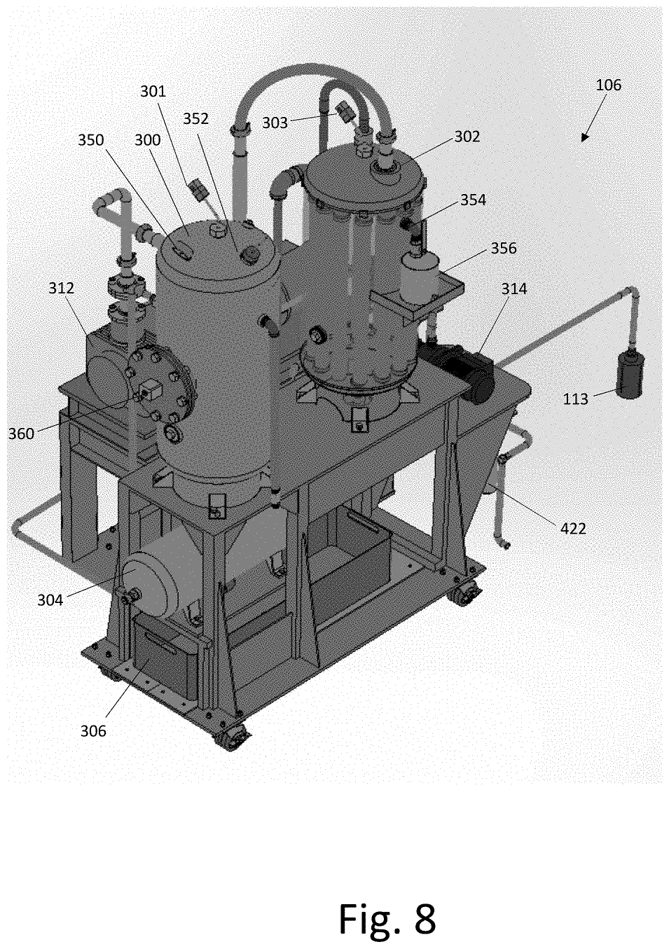

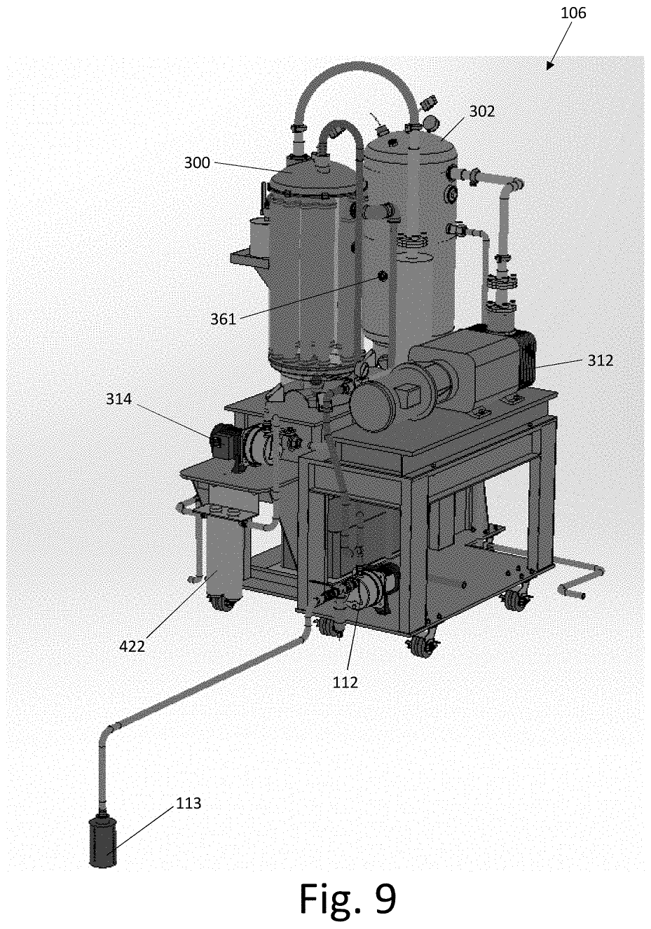

In some embodiments of the present invention, the vacuum tank 300 includes an ultrasonic device 352, a heating element 360, and a temperature probe 361 shown on the opposite side of the vacuum tank, as shown in FIGS. 8 and 9. The ultrasonic device 352 is configured for creating disturbance on the water surface in the vacuum tank 300, in order to facilitate the evaporation of the water when pressure inside the vacuum tank 300 is decreased by the dry screw vacuum pump.

The heating element 360 may be connected to the inspection cover and set at a predetermined temperature (e.g., 125 degrees Fahrenheit) and is used for heating water that has remained in the vacuum tank after the system has been shut down needs to be heated back up again. Also, on a day without any sun and using a 10-gallon hot water tank to heat the water, it may be difficult to maintain heat in the vacuum tank 300 without some type of heater to maintain the desired temperature (e.g., 104 degrees Fahrenheit), until the system 100 is up and running. When the vacuum pump 312 has been running for some time, water vapor heats up to 248 degrees Fahrenheit to warm up the water/vapor inside of the atmospheric tank 302. Water passing in the heat exchanging pipes is therefore heated via heat exchange with the water/vapor inside the atmospheric tank 302. In this manner, water arriving to the vacuum tank is already preheated via the heat exchange, the heating element in the hot water tank, and optionally by the solar collector, before arriving to the vacuum tank 300. The temperature of water inside the vacuum tank is therefore at the desired temperature (as measured by the temperature probe 361), and the heating element 360 is turned off by the temperature probe 361. The heating element 360 and the temperature probe 361 may be powered by direct current (DC) or alternating current (AC).

After a period of cycles, the brine tank 304 is filled. The top valve 308 leading to the brine tank 304 is closed and bottom valve 310 leading out of the brine tank is opened to allow the brine to be discharged into the waste tray 306 located below the brine tank. The waste tray 306 may be removed. The waste tray is open to the outside environment, enabling the brine to be dried, leaving valuable by-product, such as sodium chloride and/or other contaminants. The dry waste product can be packaged and delivered to other facilities. If the dry waste product includes sodium chloride, any unneeded material may be removed from the sodium chloride in other facilities.

In the atmospheric tank 302, the steam (water vapor and oil vapor, if present) received from the vacuum tank 300 condenses to liquid form. The condensation occurs due to the cooling of the vapor and increase in air pressure inside the atmospheric tank 302. The cooling occurs by the heat exchange between the liquid/vapor in the atmospheric tank 302 and the colder water piped from the contaminated water source passing through the heat exchange pipe 305 in the atmospheric tank 302. The vacuum pressure increase occurs as pressure is lowered in the vacuum tank 300, while air pressure is maintained at atmospheric pressure in the atmospheric tank 302. The cooling may be necessary to compensate for heat building up at the vacuum pump 312 combined with the elevated water temperature from the hot water tank 202.

Any oil present in the atmospheric tank 302 rises to the top surface of the atmospheric tank 302 as the hydrophobic forces allow oil modules to come together separating it from water. As seen in FIG. 8, the oil is removed by allowing the water surface to drain into an overflow tube 354 that is routed through a shut off valve into a container 356. The container 356 can be drained when full.

The atmospheric tank 302 has a shut-off valve open to the outside air. The shut off valve remains open providing a vent during the time water is entering and filling up inside the atmospheric tank, in order to prevent over pressuring inside the tank 302.

When the atmospheric tank 302 is full or a desired portion thereof has been filled, water from the atmospheric tank 302 is directed via a third water pump 314 to the clean water assembly 108, where more contaminants are removed and the acidity (pH) of the water is regulated. A fluoride filter 422 may be located upstream or downstream of the third pump 314, to remove contaminants from the water after leaving the atmospheric tank. The fluoride filter 422 is configured to remove Chlorine (99%), Lead (99%), Chromium 6, tastes and odors, heavy metals and 99.99% of other contaminants, while leaving essential minerals, unlike reverse osmosis systems which produce “dead water”. The clean water assembly 108 includes a manifold 400, one or more ion exchange tanks (for example a first ion exchange tank 402 and a second ion exchange tank 404) a carbon tank 406, a cation tank 408, an anion tank 410, a second filter 412, a clean tank 413, a fourth pump 414, a fifth pump 416, a first valve 418, and a second valve 420. Optionally, the clean water assembly also includes an initial filter 424 and an ultraviolet (UV) treatment device 426. The initial filter 424 is optionally a removable spin down sediment water filter includes a 50 micron filter and is used to inspect the water through the container and as a back-up safety filter before going in the UV treatment device where the water is sterilized down to 150 nanometers.

Water from the atmospheric tank 302 is directed by the third pump 314 to the initial filter 424, where particles larger than a desired size (e.g., 50 microns) are retained and prevented from going further. The UV treatment device 426 exposes the water to UV light to kill bacteria therein. Water then enters the manifold 400, which includes three exits: a first exit to the first ion exchange tank 402, a second exit to the cation tank 408, and a third exit to the anion tank 410. All three exits are closed by valves which can be opened in order to send the water to the desired tank.

Water coming from the vacuum assembly 106 is directed to the one or more ion exchange tanks (e.g., the first ion exchange tank 402 and the second ion exchange tank 404), then to the carbon tank 406, the second filter 412. The one or more ion exchange tanks and the carbon tank are used most of the time and are configured for balancing the pH of the water. If the ion exchange tank and the carbon tank are not enough to yield water having a desired pH within a desired range of pH 7 (e.g. 6.5 to 7.5, 6.7 to 7.3, 6.9 to 7.1, etc.), the action and anion tanks are needed, as explained further below. In the second filter 412, is a carbon filter. Carbon particles from the carbon tank 406 which may be larger than a desired size (e.g., 10 microns) are retained by the second filter 412. Water exiting the second filter 412 is collected by the clean tank 413. When the clean tank 413 is full, the third pump 314 is turned off and the water in the clean tank 413 is tested. If the test results are not satisfactory the clean water can be pumped into one of two different directions. Unsatisfactory test results may indicate unsafe levels in pH, coliform count, turbidity, color, and other chemical parameters. The tests may be performed in situ or in a separate testing facility.

If the tests deem the water in the clean tank 413 to be satisfactory for drinking, then the fourth pump 414 is turned on to pump the water from the clean tank 413 to the storage tank 110 (which may be part of the system 100 or may be joined to the system 100).

If the unsatisfactory result of the test is the unsafe pH level of the water, then the fifth pump 416 is activated, the second valve 420 is closed, and the first valve 418 is opened to direct the water back to the manifold 400 (via the initial filter 424 and the UV treatment device 426, if present) in which the appropriate valve is opened to direct the water to the cation tank 408 or the anion tank 410. If the water is too acidic (e.g., pH lower than 7 or lower than 6.5), then the water is sent to the anion tank 410, where excess H⁺ ions in the water combine with OH⁻ ions in the anion tank, thereby reducing acidity. If the water is too basic (e.g., pH greater than 7, greater than 7.5, or greater than 8), then the water is sent to the cation tank 408, where excess OH⁻ ions in the water combine with H⁺ ions in the cation tank, thereby reducing basicity. Water from the cation tank or anion tank is sent back to the clean tank 413. Optionally, the water is directed from the clean tank 413 to the manifold 400 via the preliminary filter 424, and the UV treatment device 426.

If the unsatisfactory result of the test is the presence of non-soluble particles and/or the presence of certain bacteria, then the manifold 400 is operated to direct the water from the clean tank 413 to the ion exchange tanks 402 and 404, the carbon tank 406, and the second filter 412, and back to the clean tank 413.

If the unsatisfactory result of the test is the presence of solutes in the water (such as salts or other soluble contaminants), then the fifth pump 416 is turned on, the first valve 418 is closed, and the second valve 420 is opened to direct the water back to the salvage tank 200. In some embodiments of the present invention, the water is directed to the salvage tank 200 via the water line from the solar collector 104 to the salvage tank 200. In such an embodiment, a third valve 107 is located along the water line leading from the solar collector 104 to the salvage tank 200 upstream of the point of entry of the water into the water line leading from the solar collector 104 to the salvage tank 200. The third valve is closed to prevent water for the clean tank from entering the solar collector 104, and for directing the water from the clean tank to the salvage tank. After reentering the salvage tank. the water will recirculate back though the solar hot water collector 104 and continue until the hot water tank valve 208 opens, allowing the water to flow to the vacuum tank for processing the source water into water vapor.

Temperature switches may be installed on the solar hot water collector 104, hot water tank 202 and the vacuum tank 300. The temperature of the water in the solar hot water collector 104 and the hot water tank 202 determine whether to energize heating elements inside the hot water tank 202. The temperature of the water in the vacuum tank 300 determines the vacuum level required to be achieved in the vacuum tank by the vacuum pump 312 in order to produce water vapor.

Optionally, a vacuum gauge 350 0-30 inHg is located outside the vacuum tank, in order to measure the vacuum pressure in the vacuum tank, as shown in FIG. 8. A Similar device could be used to transmit the measurements to the control device, so that the control device can operate the vacuum pump 312 after reaching a desired vacuum pressure.

In some embodiments of the present invention, a water flow meter 700 may be installed in system 100 and connected to a recording device (i.e., chart recorder, electronic recorder or computer) to monitor the amount of water used in the system. The flow meter may be installed anywhere in the system, for example along the water line between the fourth pump 414 and the storage tank 110. This can be a viable method to determine when to replace the cation, anion, ion exchange tanks, carbon tank, and to replace the fluoride filters and the 10 micron filter elements, the lifetime of which depends on water than has flowed therethrough.

The system 100 is electrically efficient. This is because not all of the three assemblies (102, 106, and 108) operate at the same time. To make an efficient system the different components are operated only when required. This is similar to an on-demand electrical system.

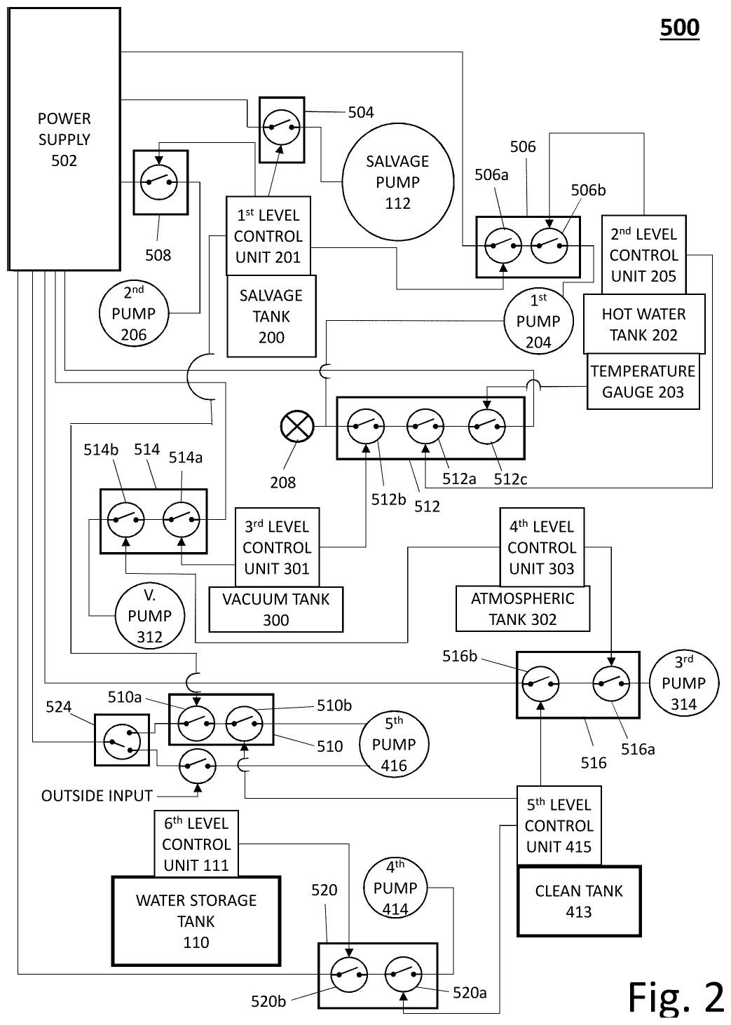

FIG. 2 is a block diagram illustrating an example of an electrical power apparatus 500 for automatically controlling electrical power flow to the different units of the water purification system 100 of FIG. 1.

The electrical power apparatus 500 includes a power supply 502, a first level control unit 201 associated with the salvage tank 200, a second level control unit 205 associated with the hot water tank 202, a temperature gauge 203 associated with the hot water tank 202, a third level control unit 301 associated with the vacuum tank 300, a fourth level control unit 303 associated with the atmospheric tank 302, a fifth level control unit 415 associated with the clean tank 413, a sixth level control unit 111 associated with the water storage tank 110, a plurality of power lines configured for supplying power from the power supply 502 to all tanks and pumps, and a plurality of switching units disposed along the power lines and configured for being controlled by one or more of the level control units. The water level control units may, for example, include float switches that switch on and off according to the level of water in the respective tanks.

The first water level control unit 201 is associated with the salvage tank 200 and is configured for controlling power transmission to the salvage pump 112 via a first switching unit 504, to the first pump 204 via a second switching unit 506, to the second pump 206 via a third switching unit 508, and to the fifth pump 416 via a fourth switching unit 510, according to the level of water in the salvage tank 200.

The second water level control unit 205 is associated with the hot water tank 202 and is configured for controlling power transmission to the first pump 204 via the second switching unit 506 and to the salvage valve 208 via a fifth switching unit 512, according to the level of water in the hot water tank 202.

The temperature gauge 203 is associated with the hot water tank 202 and is configured for measuring the temperature of water in the hot water tank 202. The temperature gauge 203 is configured for controlling power transmission to the salvage valve 208 via the fifth switching unit 512 according to the temperature of the water in the hot water tank 202.

The third water level control unit 301 is associated with the vacuum tank 300 and is configured for controlling power transmission to the salvage valve 208 via the fifth switching unit 512 and to the vacuum pump 312 via a sixth switching unit 514, according to the level of water in the vacuum tank 300.

The fourth water level control unit 303 is associated with the atmospheric tank 302 and is configured for controlling power transmission to the vacuum pump 312 via the sixth switching unit 514 and to the third pump 314 via a seventh switching unit 516, according to the level of water in the atmospheric tank 302.

The fifth water level control unit 415 is associated with the clean tank 413 and is configured for controlling power transmission to the third pump 314 via the seventh switching unit 516, of the fourth pump 414 via a ninth switching unit 520, and of the fifth pump 416 via the fourth switching unit 510, according to the level of water in the clean tank 413.

The sixth water level control unit 111 is associated with the water storage tank 110 and is configured for controlling power transmission to the fourth pump 414 via the ninth switching unit 520, according to the level of water in the water storage tank 110.

An eleventh switching unit 524 operated by the user allows the user to choose how power transmission to the fifth pump 416 is controlled. If water is to be directed from the clean tank 413 to the salvage tank 200, then the tenth switching unit is operated to enable the first level control unit 201 to control the operation of the fifth pump 416 according to the level of water in the salvage tank 200 and to enable the fifth level control unit 415 to control the operation of the fifth pump 416 according to the water level in the clean tank 413. If water is to be directed from the clean tank 413 back to the clean tank 413 via different filters (as described above), then the tenth switching unit 524 is operated by an outside input (e.g., user or automatic central control unit) to enable electrical power to reach the fifth pump 416.

When the first water level control unit 201 detects that the salvage tank 200 is sufficiently full (i.e., water level in the salvage tank is higher than a first predetermined level), the first water level control unit 201 causes the first switching unit 504 to cut power transmission from the power supply to the salvage pump 112, thereby turning the salvage pump off.

When the water level in the salvage tank 200 is at the desired level, the first level control unit 201 allows electrical current to be transmitted to the second pump 206, by controlling the third switching unit 508. The water is therefore circulated through the solar collector 104 using the second water pump 206, which provides enough pressure to keep the water circulating in a closed loop back to the salvage tank 200.

When the salvage tank 200 is full again up to a desired level, the first level control unit 201 controls the second switching unit 506 to allow electrical current to be transmitted from the power supply 502 to the first pump 204. The second switching unit is also controlled by the second water level control unit associated with the hot water tank. If the salvage tank 200 is sufficiently full (water level above a first predetermined threshold) and the hot water tank 202 is sufficiently empty (water level below a second predetermined threshold), then the second switching unit enables current transmission to the first pump 204, in order to allow operation of the first pump to transfer water from the salvage tank 200 to the hot water tank 202.

In some embodiments of the present invention, the second switching unit 506 includes a first switch 506a and a second switch 506b in series along the electrical line feeding the first pump 204. The first switch 506a is controlled by the first water level control unit 201 to allow passage of electrical current to the first pump 204 if the salvage unit 200 is sufficiently full. The second switch 506b is controlled by the second water level control unit 205 to allow passage of electrical current to the first pump 204 if the hot water tank 202 is sufficiently empty. Therefore, for electrical current to be transmitted to the first pump 204 and the first pump 204 to be activated, both switches need to allow passage of current, i.e., both conditions for activating the first pump 204 (salvage tank sufficiently full and hot water tank sufficiently empty) need to be fulfilled.

When the first pump 204 is activated, water is transferred from the salvage tank 200 to the hot water tank 202. If the water temperature is below a desired temperature (e.g., 104 degrees Fahrenheit) in the hot water tank 202, the temperature gauge 203 associated with the hot water tank turns on electrical power in the heater elements of the hot water tank 202 to heat the water. If the water temperature is above a desired temperature (e.g., 104 degrees Fahrenheit) in the hot water tank 202, the temperature gauge 203 associated with the hot water tank ensures that electrical power is not turned on in the hot water tank 202 to heat the water.

Electrical current transmission to the salvage valve 208 is controlled via a fifth switching unit 512. The operation of the fifth switching unit is controlled by the second water level control unit 205 associated with the hot water tank 202, the temperature gauge 203 associated with the hot water tank 202, and by the third water level control unit 301 associated with the vacuum tank 300. The fifth switching unit 512 is configured for transmitting electrical power to the salvage valve to open the salvage valve to enable transfer of water from the hot water tank 202 to the vacuum tank 300 if all the following conditions are fulfilled: the hot water tank 202 is sufficiently full (controlled by the second water level control unit 205), the vacuum tank 300 is sufficiently empty (controlled by the third water level control unit 301), the temperature of the water in the hot water tank is above a predetermined level (controlled by the temperature gauge 203).

Simultaneously, the fifth switching unit 512 is also configured for transmitting electrical power to the first pump 204 to pump water from the hot water tank 202 to the vacuum tank 300 if all the following conditions are fulfilled: the hot water tank 202 is sufficiently full (controlled by the second water level control unit 205), the vacuum tank 300 is sufficiently empty (controlled by the third water level control unit 301), the temperature of the water in the hot water tank is above a predetermined level (controlled by the temperature gauge 203). It should be noted that the fifth switching unit 512 is in parallel with the second switching unit 506. This means that electrical power is transmitted to the first pump 204, even if only one of the second switching unit 506 and the fifth switching unit 512 enables power transmission from the power supply 502 to the first pump 204.

Optionally, the fifth switching unit 512 includes three switches 512a, 512b, 512c disposed in series along the electrical line from the power supply 502 to the salvage valve 208 and controlled respectively by the second water level control unit 205, the third water level control unit 301, and the temperature gauge 203.

As the water enters the vacuum tank 300, the water level in the vacuum tank rises until the vacuum tank 300 is sufficiently full. At this point, the vacuum pump 312 is to be activated in order to lower the air pressure in the vacuum tank to vaporize the water in the vacuum tank 300 and to transfer the vapor to the atmospheric tank 303. In the atmospheric tank 302, the vapor is converted back to liquid water, filling the atmospheric tank 302. The vacuum pump 312 is to be deactivated when the atmospheric tank 302 is sufficiently full.

Therefore, the transmission of electrical current to the vacuum pump is controlled by a sixth switching unit 514, which is in turn controlled by the third water level control unit 301 and by the fourth water level control unit 303. The sixth switching unit 514 enables electrical power to be transmitted to the vacuum pump only when both of the following conditions are fulfilled: the third water level control unit 301 determines that the vacuum tank 300 is sufficiently full, and the fourth water level control unit 303 determines that the atmospheric tank 302 is sufficiently empty. If any of these conditions is not fulfilled, the sixth switching unit 514 does not allow electrical current to flow to the vacuum pump 312.

In some embodiments of the present invention, the sixth switching unit 514 includes the switches 514a and 514b disposed in series along the power line to the vacuum pump and respectively controlled by the third water level control unit 301 and the fourth water level control unit 303.

The third water pump 314 is configured to pump water from the atmospheric tank 302 to the clean tank 413. Transmission of electrical power to of the third water pump 314 is controlled by the seventh switching unit 516, which is in turn controlled by the fourth water level control unit 303 (which determines the water level in the atmospheric tank 302) and by the fifth water level control unit 415 (which determines the water level in the clean tank 413). Power is transmitted to the fourth pump only if the atmospheric tank 302 is sufficiently full and the clean tank 413 is sufficiently empty. If any of these conditions is not true, power to the third pump 314 is cut. When the third pump 314 is on, water from the atmospheric tank 302 is piped through the fluoride filters 422 into the clean tank assembly. The third water pump 314 continues operating until the clean tank 413 is filled to a desired level.

In some embodiments of the present invention, the seventh switching unit 516 includes two switches 516a and 516b disposed in series along the electrical line from the power supply 502 to the third pump 314 and respectively controlled by the fourth water level control unit 303 and the fifth water level control unit 415. The fourth water level control unit 303 controls the switch 516a to allow passage of electrical current to the third pump 314 only if the atmospheric tank 302 is sufficiently full (water level above a predetermined level). The fifth water level control unit 415 controls the switch 516b to allow passage of electrical current to the third pump 314 only if the clean tank 413 is sufficiently empty (water level below a predetermined level).

The water in the clean tank 413 can be tested in order to verify its purity. If the purity of the water in the clan tank is acceptable, the fourth pump 414 is turned on to transfer the clean water from the clean tank 413 to the storage tank 110.

Transmission of electrical power to of the fourth water pump 414 is controlled by the ninth switching unit 520, which is in turn controlled by the fifth water level control unit 415 (which determines the water level in the clean tank 413) and by the sixth water level control unit 111 (which determines the water level in the water storage tank 110). Power is transmitted to the fourth pump 414 only if the clean tank 413 is sufficiently full and the water storage tank 110 is sufficiently empty. If any of these conditions is not true, power to the fifth pump 414 is cut.

In some embodiments of the present invention, the ninth switching unit 520 includes two switches 520a and 520b disposed in series along the electrical line from the power supply 502 to the fourth pump 414 and respectively controlled by the fifth water level control unit 415 and the sixth water level control unit 111. The fifth water level control unit 415 controls the switch 520a to allow passage of electrical current to the fourth pump only if the clean tank 413 is sufficiently full (water level above a predetermined level). The sixth water level control unit 111 controls the switch 520b to allow passage of electrical current to the fourth pump only if the water storage tank 110 is sufficiently empty (water level below a predetermined level).

The fifth pump 416 is configured for pumping water from the clean tank 413 to the salvage tank 200 or from the clean tank 413 back to itself (through various filters), depending on the results of the testing of the water in the clean tank 413. As mentioned above, the user operates the eleventh switching unit 524 to choose whether power transmission to the fifth pump 416 is controlled by the first level control unit 201 associated with the salvage tank 200 or by the first level control unit 201 together the fifth level control unit 415 associated with the clean tank 413.

If water is to flow from the clean tank 413 to the salvage tank 200, the user may select an option whereby the operation of the fifth pump 416 is controlled by the fourth switching unit 110, which is controlled by fifth level control unit 415 and the first level control unit 201. In some embodiments of the present invention, electrical power is supplied to the fifth pump 416 if the clean tank 413 is sufficiently full and the salvage tank 200 is sufficiently empty. In some embodiments of the present invention, the fourth switching unit 510 includes a first switch 510a and a second switch 510b in series along the electrical line feeding the fifth pump 416. The first switch 510a is controlled by the first water level control unit 201 to allow passage of electrical current to the first pump 204 if the salvage unit 200 is sufficiently empty. The second switch 510b is controlled by the fifth water level control unit 415 to allow passage of electrical current to the fifth pump 416 if the clean tank 413 is sufficiently full. Therefore, for electrical current to be transmitted to the fifth pump 416 and the fifth pump 416 to be activated, both switches need to allow passage of current, i.e., both conditions for activating the fifth pump 416 (salvage tank sufficiently empty and clean tank sufficiently full) need to be fulfilled. For the fifth pump 416 to be energized, both switches need to be closed.

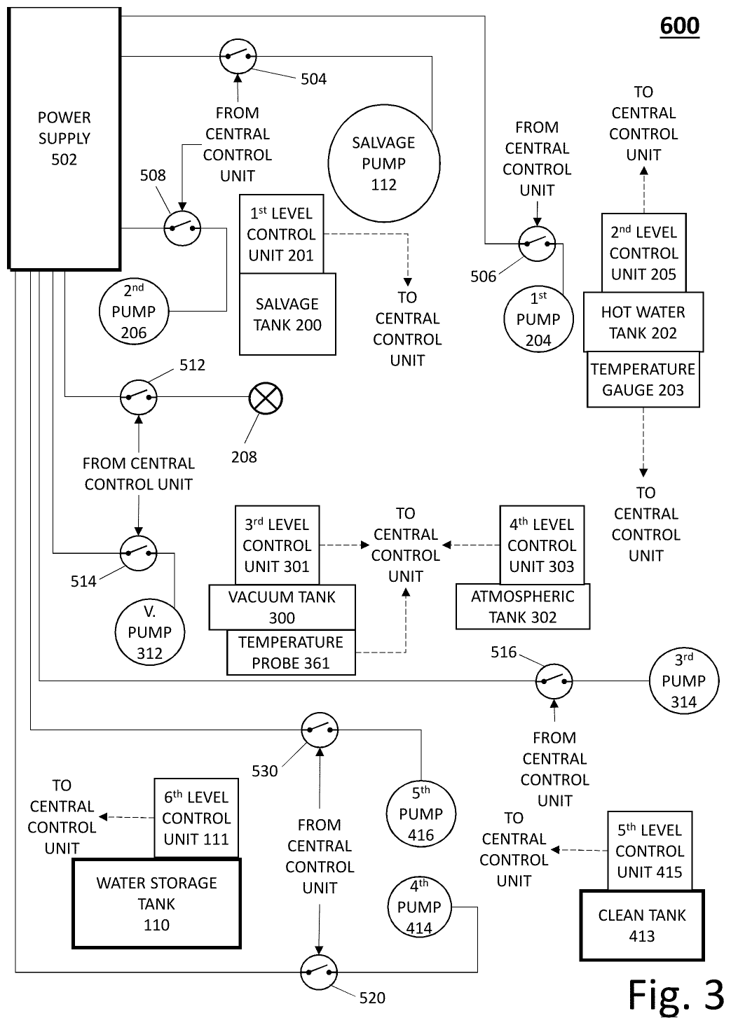

FIG. 3 is a block diagram illustrating some embodiments of the present invention, in which the operation of the system 100 is configured to be controlled by a central control unit, programmable logic controller (PLC). According to some embodiments of the present invention, a central control unit is configured for receiving information in the form of electrical signals from the water level control units and from the temperature gauge 203, and to enable operation of the pumps and the salvage valve 208 accordingly.

The central control unit includes a processing unit and a memory unit including instructions for processing the information received by the water level control units and by the temperature gauge, and for selectively activating the different pumps and the salvage pump 208 according to the instructions and to the input information.

In another variant, the central control unit includes a control panel in which the status of the different water level control units and the temperature gauge is displayed to a user. The control unit includes an input device, in which the user can operate each pump and the salvage valve, according to the displayed status.

In a further variant, the central control unit is configured for operating some elements of the system 100 automatically and requires user input for the operation of other elements of the system 100.

In yet a further variant, called Manual Control, there is no central control unit. Each water level control unit displays water level near the respective tank and the temperature gauge displays the water temperature in the hot water tank 202 at the hot water tank 202. The operation of each of the pumps requires the user to turn on the pump, and the operation of each valve requires the user to manually open or close the valve.

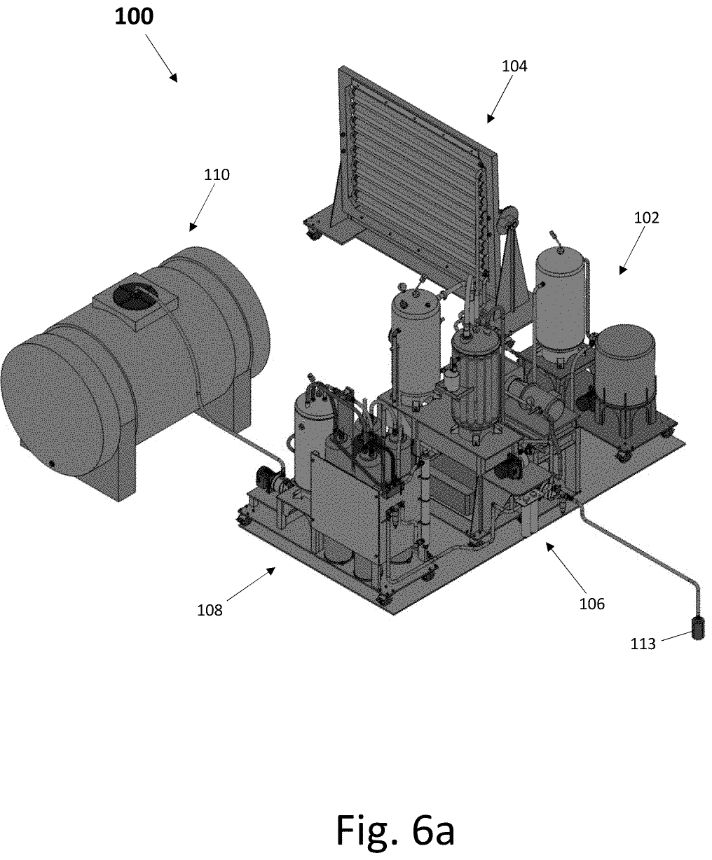

FIG. 5 is a block diagram illustrating an example of the power supply 502, according to some embodiments of the present invention.

In the example of FIG. 5, the power supply 5 includes an AC plug 600, an AC transformer 602, a DC plug 604, a DC transformer 608, and a battery array 610.

The AC plug 600 is configured to be plugged into and receive power from an AC power source, such as the electrical grid. AC power flows to the AC transformer 602, which converts the AC power to power usable to charge the battery array 610. Similarly, the DC plug 604 is configured to be plugged into and receive power from a DC power source, such as a generator or photovoltaic electrical generators. DC power flows to the DC transformer 608, which converts the AC power to power usable to charge the battery array 610.

The battery array 610 includes one or more rechargeable batteries that are configured for releasing electrical power to the various units of the water purification system 100.

To reduce the amount of purchased electrical power one can take advantage of using existing solar panels, wind power turbines, solar hot water collector and portable electric generators. The electrical apparatus of the system 100 can connect to the local electrical grid during low demand times. The batteries may be charged when the electrical apparatus of the system 100 is connected to the local electrical grid, or receiving power from solar panels, wind power turbines, solar hot water collector and portable electric generators.

In order to further reduce the power consumption of the system 100, the water flow rate is kept low and the size of the different tanks is designed so that the effective height through which the flow is to be pumped is only approximately five feet. In addition, power consumption is affected by the distance the water is traveling inside the hoses or pipes and friction inside the pipe or the hoses piped and pipe friction. Therefore, the length of the piping or hoses is minimized, and the pipes or hoses are made of a low friction material, such as plastic. Pumps are usually 50-85% efficient, electric pump motors such as the 5 HP dry vacuum pump electric motor and the 1.6 HP water pump electric motors are usually 80-95% efficient.

The inventors have estimated that about 7.5 kW are needed to power the system 100 of the present invention. Therefore, a portable 10 kW generator readily available in the market can be used to power the system 100 of the present invention.

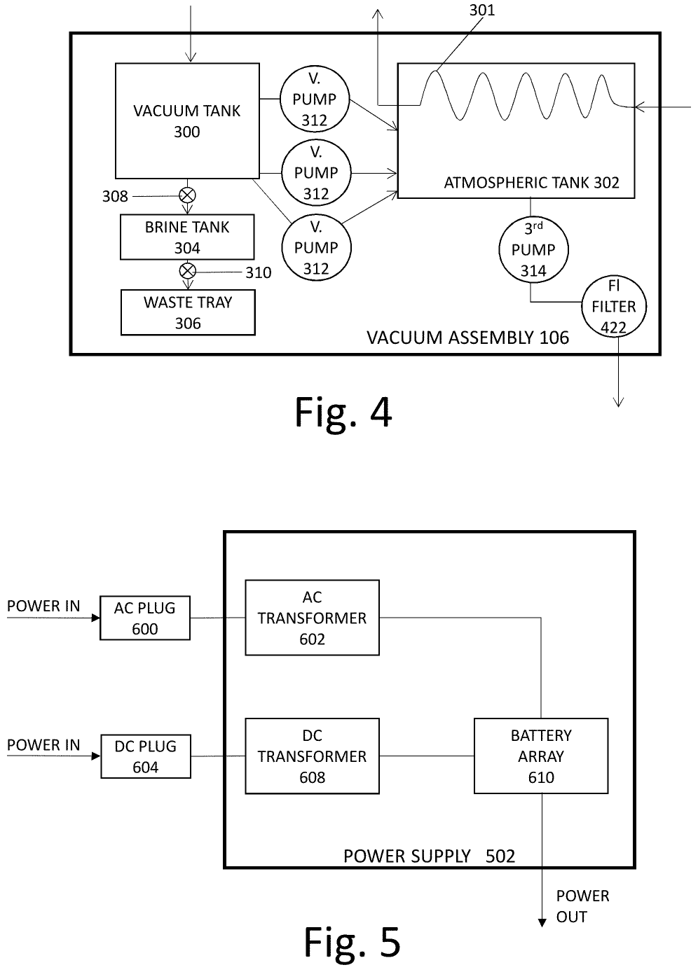

Another advantage of the water purification system 100 is portability. For reference, “Basic Science Concepts and Applications” by American Water Works Association (see page 155 for Mathematics Per Capita Water Use, page 155 for Domestic Water Use Based on Household Fixture Rate, page 167 for Average Daily Flow) estimates that a four-person family generally uses 366.85 gallons of water per day (gpd). In some embodiments of the present invention, the WDS assembly footprint is approximately 6 feet by 10 feet. This area does not include the solar hot water collector 104 or the clean water storage tank 110, which may be variable in size. In some embodiments of the present invention, the inventors have concluded that the system 100 described above and having an approximate footprint of 6 feet by 10 feet can be used to purify about 26 gallons per day. The quantity of potable water can be increased by providing more dry vacuum pumps to the vacuum assembly. This is because, a single SVD-200 dry pump pumps 9 pounds of water per hour and is the slowest of the pumps. Therefore, providing more vacuum pumps would increase the daily production of potable water by the system 100. The example of FIG. 4 illustrates a vacuum assembly 106 which includes a plurality of vacuum pumps 312 in parallel with each other, configured for pump the vapor from the vacuum tank 300 to the atmospheric tank 302.

In some embodiments of the present invention, the system 100 is compact enough to be placed in the bed of a pickup truck. In a non-limiting example, the salvage tank 200, the vacuum tank 300, the atmospheric tank 312, and the clean tank 413 are 30-gallon tanks. The hot water tank 202 and the brine tank 304 are 10-gallon tanks. The ion exchange tanks 402 and 404, the carbon tank 406, the cation tank 408, the anion tank 410 are 10-gallon tanks. The tanks may, for example be steel ASTM A-36 tanks which are pressure tested to 200 psi and treated with rust preventive paint. The inventors have found that scaling down the system 100 in size would generate less water but still require the same amount of power to operate. Each of the three sub-assembly tanks have float level instruments located on top of the tank. When the water level float descends to the preset position the instruments electrical contact turns on the electric water pump. When the water level rises to the preset position the instruments electrical contact turns off the electric water pump. The electrical water pumps have an on/off manual switch which allows manual override of control when the system 100 is controlled by a Central Processing Unit or a PLC.

The system 100 can be operated manually or may be operated via an automatic control device. If the system 100 is to be operated manually, the valves in the manifold 400 and the valves 418 and 420 may be manually operated valves, such as ball valves

If the system 100 is operated by an automatic control device (e.g., a computer), electrical solenoid operated ball valves are used. An example of a solenoid operated ball valve is the ¾″ NPT Solenoid valve 120/60 110/50 ¾″ Orifice, which may be purchased on Amazon. As mentioned above, the operation of the pumps may be dictated by water level control units (e.g., float level indicators) included in all the vertical tanks.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

What is claimed is:

1. A water purification system comprising:
i. a salvage pump, configured to draw water from a water source;
ii. a salvage assembly, comprising:
a salvage tank configured to store water drawn by the salvage pump;
a hot water tank, configured to receive water from the salvage tank and for heating and storing the received water;
a first pump, configured to pump water from the salvage tank to the hot water tank;
a salvage valve, configured to regulate water flow out of the hot water tank;
iii. a vacuum assembly, comprising:
a vacuum tank, configured to receive water from the hot water tank;
a vacuum pump, configured to lower pressure inside the vacuum tank to cause evaporation of water stored in the vacuum tank, and to draw water vapor from the vacuum tank;
an atmospheric tank, configured to be maintained at an atmospheric pressure and to receive the water vapor drawn by the vacuum tank, the atmospheric tank being configured to transform water vapor received from the vacuum pump into water;
a heat exchanger pipe traversing the atmospheric water tank and configured to lead water from the salvage pump to the salvage tank without contacting the water and water vapor in the atmospheric tank, thereby warming the water in the heat exchanger pipe while cooling the water and water vapor inside the atmospheric tank;
a second pump, configured to draw water out of the atmospheric tank;
iv. a clean water assembly, comprising:
a plurality of filters, configured to filter water drawn by the second pump;
a clean tank, configured to receiving water that has been filtered by the plurality of filters;
a third pump, configured for drawing water from the clean tank to a water storage tank;
a fourth pump, configured for drawing water from the clean tank and leading the water drawn from the clean tank into a further purification cycle.

2. The water purification system of claim 1, further comprising a fifth pump and a solar collector, wherein:
the fifth pump is configured to drive water from an outlet of the salvage tank to an inlet of the solar collector, via the solar collector, via an outlet of the solar collector, and back into the salvage tank via an inlet of the salvage tank;
the solar collector is configured for using solar power to heat water flowing in the solar collector.

3. The water purification system of claim 1, wherein:
the vacuum assembly comprises a brine tank located under the vacuum tank and communicating with the vacuum tank via a first water line opened and closed via a first valve;
when the first valve is opened, brine collected at a bottom of the vacuum tank enters the brine tank.

4. The water purification system of claim 3, wherein the vacuum assembly comprises a waste tray located under an outlet of the brine tank;
the outlet of the brine tank is opened and closed via a second valve;
when the second valve is opened, the brine collected in the brine tank enters the waste tray.

5. The water purification system of claim 4, wherein the waste tray is removable from under the outlet of the brine tank.

6. The water purification system of claim 1, further comprising a fluoride water filter located downstream of the second pump.

7. The water purification system of claim 1, wherein the clean water assembly comprises a manifold, at least one ion exchange tank, a carbon tank, a cation tank, and an anion tank, wherein:
the manifold comprises an inlet for receiving water from the second pump, a first exit line, a second exit line, and a third exit line, each exit line being openable and closable by a respective valve;
the first exit line leads to the least one ion exchange tank;
the at least one ion exchange tank has an outlet leading to the carbon tank, which has a first outlet leading to the clean tank;
the second exit line leads to the cation tank, which has a second outlet leading to the clean tank;
the third exit line leased to the anion tank, which has a third outlet leading to the clean tank;
the at least one ion exchange tank and the carbon tank are configured to balance the pH of water flowing therethrough;
the cation tank contains H⁺ ions, and is configured to decrease a basicity of water flowing therethrough by neutralizing excess OH⁻ ions in the water with the H⁺ ions in the cation tank;
the anion tank contains OH⁻ ions, and is configured to decrease an acidity of water flowing therethrough by neutralizing excess H⁺ ions in the water with the OH⁻ ions in the anion tank.

8. The water purification system of claim 7, comprising an initial filter located upstream of the manifold and configured for retaining particles larger than a first predetermined size.

9. The water purification system of claim 7, comprising a second filter located between the carbon tank and the clean tank, and configured for retaining particles larger than a second predetermined size.

10. The water purification system of claim 7, comprising an ultra violet (UV) treatment device located upstream of the manifold and configured to expose water to UV light to kill bacteria in the water.

11. The water purification system of claim 1, wherein:
the fourth pump is configured to draw water from the clean tank and deliver the water to a first return water line and to a second return water line;
the first return water line leads water drawn by the fourth pump back to the plurality of filters;
the second return water line leads water drawn by the fourth pump back to the salvage tank;
a first return valve is located along the first return water line to enable the first return water line to be opened and closed;
a second return valve is located along the second return water line to enable the second return water line to be opened and closed.

12. The water purification system of claim 1, further comprising a water flow meter installed along any water line of the system to monitor an amount of water used in the system.

13. The system of claim 1, wherein:
the hot water tank comprises a first temperature gauge and a heating element;
the first temperature gauge is configured to measure temperature of the water in the hot water tank and for activating the heating element so as to maintain the water in the hot water tank above a desired temperature or within a desired range of temperatures.

14. The system of claim 1, comprising:
a first level control unit configured to monitor a first water level in the salvage tank;
a second level control unit configured to monitor a second water level in the hot water tank;
a third level control unit configured to monitor a third water level in the vacuum tank;
a fourth level control unit configured to monitor a fourth water level in the atmospheric tank;
a fifth level control unit configured to monitor a fifth water level in the clean tank;
a sixth level control unit configured to monitor a sixth water level in the water storage tank; and
a first temperature gauge is configured to measure temperature of the water in the hot water tank.

15. The system of claim 14, wherein:
the salvage pump is configured to be activated if the first level control unit indicates that the first water level in the salvage tank is below a predetermined level;
the first pump is configured to be activated:
if the first level control unit indicates that the first water level in the salvage tank is above a first predetermined level and the second level control unit indicates that the second water level in the hot water tank is below a second predetermined level; or
if the second level control unit indicates that the second water level in the hot water tank is above a third predetermined level, and the third level control unit indicates that the third water level in the vacuum water tank is below a fourth predetermined level, and the first temperature gauge indicates that the temperature of the water in the hot water tank is higher than a first predetermined temperature;
the vacuum pump is activated if the third level control unit indicates that the third water level inside the vacuum tank is above a fifth predetermined level and the fourth level control unit indicated that the fourth water level in the atmospheric tank is below a sixth predetermined level;
the second pump is activated if the fourth level control unit indicates that the fourth water level in the atmospheric tank is above a seventh predetermined level and the fifth level control unit indicates that the fifth water level in the clean tank is below an eighth predetermined level;
the third pump is activated if the fifth level control unit indicates that the fifth water level in the clean tank is above a ninth predetermined level and the sixth level control unit indicates that the sixth water level is below an eleventh predetermined level; and
the fourth is activated either by an outside input or if the fifth level control unit indicates that the fifth water level in the clean tank is above a ninth predetermined level and the sixth level control unit indicates that the sixth water level is below an eleventh predetermined level.

16. The system of claim 15, wherein:
the salvage valve remains open if and only if the second level control unit indicates that the second water level in the hot water tank is above a third predetermined level, and the third level control unit indicates that the third water level in the vacuum water tank is below a fourth predetermined level, and the first temperature gauge indicates that the temperature of the water in the hot water tank is higher than a first predetermined temperature.

17. The system of claim 15, wherein the sixth pump is activated when the first level control unit indicates that the first water level in the salvage tank is above the first predetermined level.

18. The system of claim 14, further comprising a temperature probe configured for measuring a temperature of water in the vacuum tank.

19. The system of claim 14 comprising a central control unit configured for receiving inputs from at least some of the level control units and from the temperature gauge, and for activating the salvage pump, the vacuum pump, the first pump, the second pump, the third pump, the fourth pump, and the fifth pump accordingly.

20. The system of claim 14, wherein outputs from at least some of the level control units and from the temperature gauge are displayed for being readable by a user, and each pump and valve is configured to be activated by the user.
